(19) United States
(12) Patent Application Publication
(10) Pub. No.: US 2006/0286980 A1
(43) Pub. Date: Dec. 21, 2006

(54) Methods and systems for managing multiple registration and incoming call routing for mobile user equipment in wireless/IMS networks

(75) Inventor: Shiyan Hua, Lisle, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/153,081

(22) Filed: Jun. 15, 2005

(51) Int. Cl. H04Q 7/20

(52) U.S. Cl. 455/435.1; 455/433

(57) ABSTRACT

Systems and methods are presented for registering and routing incoming calls to a dual mode user equipment operable in a plurality of mobile communications networks. A latest registered network indicator is maintained and updated to indicate the network with which the user equipment has most recently registered, such as cellular network or IP-based network. Incoming calls are routed to the indicated network even where the user equipment was previously registered with a non-indicated network to resolve dual registration issues between different network types without having to attempt call delivery in both networks.

### FIELD OF THE INVENTION

The present invention relates to telecommunications in general, and more particularly to systems and methods for managing registration and call routing for multimode user equipment in wireless and IMS communications networks.

### BACKGROUND OF THE INVENTION

Mobile communications systems provide subscribers or users the opportunity to travel from place to place while maintaining the ability to communicate via mobile units or user equipment, such as cell phones, pagers, PDAs, laptop computers, etc. As a result, mobile communications has enjoyed enormous success in recent years. Different types of wireless mobile communications networks have been developed, including cellular networks (e.g., ANSI41 type networks, GSM networks, etc.) that operate according to signaling protocols such as signaling system 7 or common channel signaling 7 (e.g., SS7 or CCS7), as well as IMS/WiFi networks (Internet Protocol Multimedia Subsystem/Wireless Fidelity) or other internet protocol (IP) based networks. Single mode user equipment (e.g., cell phones) typically include the wireless communications hardware to interface the equipment with the communications medium, along with protocol functionality to support interaction and data exchange with a given mobile communications network type, wherein the user subscribes to a network service provider operating a certain type of network. Individually operated wireless networks typically do not extend across the entire surface of the earth, wherein most cellular networks are adapted to provide communications service to non-subscribing visiting user equipment that moves or roams into an area not supported by the subscribed (home) network. Furthermore, complete nation-wide service is currently not available for a given network type, wherein cellular service may not be available in a given location, and other locations may not have IMS/WiFi service.

Because the individual types of networks do not currently provide services in all locations, so-called dual mode or multimode user equipment (e.g., DM UE) may be desirable to provide improved connectivity for mobile users. With this type of equipment, a user may be an IMS/WiFi subscriber with the capability to communicate in IP-based networks, as well as the ability to also communicate via traditional cellular networks, for example, when the dual mode user equipment is located in an area where ANSI41 or other cellular services are available but where no IMS/WiFi communications is possible (or vice versa). Alternatively, the dual mode equipment may be a subscriber with a cellular network operator, with services also being available in IMS WiFi networks. In this manner, the user has fewer geographical limitations and is more likely to be able to communicate at a given location. When such IMS and Cellular dual mode user equipment moves between IMS/WiFi and Cellular networks, both networks may have a separate registration, including one registration at a home subscriber server (HSS) of the IMS/WiFi network and another registration at a home location register (HLR) or visitor location register (VLR) of an ANSI41 type cellular network. However, IMS networks do not have a mechanism to cancel the IMS registration immediately when the user equipment moves to (e.g., registers with) a different (e.g., cellular) network, whereby it is difficult for a global roaming application server (GRAS) to deliver an incoming call without trying both networks or network types. Accordingly, there is a need for registration and call delivery systems and techniques to allow a GRAS to more easily direct incoming calls to multimode user equipment without expending resources attempting to route the call through more than one network.

### SUMMARY OF THE INVENTION

A summary of one or more aspects of the invention is now presented to facilitate a basic understanding thereof, wherein this summary is not an extensive overview of the invention, and is intended neither to identify certain elements of the invention, nor to delineate the scope of the invention. Rather, the primary purpose of the summary is to present some concepts of the invention in a simplified form prior to the more detailed description that is presented hereinafter. The invention relates to systems and methodologies for tracking and determining which dual or multimode user equipment registration is most recent, by which a global roaming application server or other system entity can deliver the call to the latest registered network without unnecessarily attempting delivery in a network from which the user equipment has already exited.

One aspect of the invention provides a method for registration management registration of dual mode user equipment in a mobile communications system. When a message is received requesting registration by a dual mode user equipment (DM UE) in a first mobile communications network, the user equipment is selectively registered as per the applicable registration conditions for the particular network type. The registration management method further provides for updating an indicator, referred to herein as a latest registered network (LRN) indicator in a data store associated with the first communications network, where the updated LRN is indicative of the first mobile communications network. The data store can be any data base or memory system which is directly or indirectly accessible by two or more mobile communications networks including the first network at which the equipment is registering. As the DM UE thereafter registers in a second network, the LRN indicator is again updated to be indicative of the second mobile communications network. The data store in one implementation is an integrated data store comprising a home location register (HLR) associated with a cellular network and a home subscriber server (HSS) associated with the IP-based network, where the LRN indicator can be associated with either the HLS or the HSS or both. In this case, when the DM UE registers with the IP-based (e.g., IMS) network, the serving call session control function (CSCF) obtains the necessary profile and other information to provide communications service to the DM UE and also causes the LRN to be updated. Similarly, when the DM UE roams to an ANSI41 type cellular network, the corresponding mobile switching center (MSC) registers the equipment and updates the LRN to indicate current cellular registration. In this manner, the LRN can be queried at any given time by elements of either network or by a global roaming application server (GRAS) to ascertain the location of the DM UE (i.e., the network with which the DM UE most recently registered).

The method may further include selectively routing an incoming call to the DMUE according to the LRN (e.g., delivering the call using the network indicated by the LRN indicator). In one example, the DM UE is capable of communicating in both cellular (e.g., ANSI41 and/or GSM) networks, as well as IP-based (e.g., IMS/WiFi) networks, where the incoming call is initially routed to a network element of the subscriber's home network (e.g., home MSC for ANSI41 cellular subscriber, or CSCF for IMS/WiFi subscriber), which ascertains the profile information for the equipment. This profile information indicates that the equipment is a dual mode device, and the network element accordingly involves a global roaming application server (GRAS) to route the call. The GRAS checks the LRN indicator and attempts call delivery using the network indicated by the LRN. In this fashion, only the most recently registered network is used in attempting call delivery and the resources of other previously visited networks need not be expended for incoming calls to the DM UE.

Another aspect of the invention provides a method for routing an incoming call to a dual mode user equipment in a mobile communications system, including checking a LRN indicator associated with the DM UE, where the LRN is indicative of one of a plurality of mobile communications networks. The method also provides for routing the incoming call to the DM UE via a selected one of the networks according to the LRN indicator. The method may further comprise updating the LRN indicator when the DM UE registers with another network.

Yet another aspect of the invention provides system for routing incoming calls to a dual mode user equipment using one of a plurality of mobile communications networks. The system includes a LRN indicator for indicating one of a plurality of mobile communications networks with which a given dual mode user equipment has most recently registered, along with means for routing the incoming call to the given dual mode user equipment via a selected one of the networks according to the LRN indicator. The LRN may be maintained (e.g., stored or saved) in a data store accessible by the plurality of networks, such as in an integrated data store comprising an HLR associated with a cellular network and an HSS associated with an IP-based network. The routing means in one implementation may comprise a GRAS associated with the plurality of networks. The DM UE, moreover, may be a subscriber in a first network and a network element of the first network directs incoming calls to the GRAS for routing to the DM UE via a selected one of the plurality of mobile communications networks according to the LRN indicator. In one example where the first (e.g., home) network is an ANSI41 type cellular network, the network element can be an HLR or MSC, whereas if the home network is IP-based (e.g., IMS/WiFi), the network element can be a CSCF, which employs the GRAS to route the call according to the LRN indicator.

### BRIEF DESCRIPTION OF THE DRAWINGS

The following description and drawings set forth in detail certain illustrative implementations of the invention, which are indicative of several exemplary ways in which the principles of the invention may be carried out. Various objects, advantages, and novel features of the invention will become apparent from the following detailed description of the invention when considered in conjunction with the drawings, in which:

FIG. 1A is a flow diagram illustrating an exemplary method for managing registration of multimode user equipment in a wireless communications system according to one or more aspects of the present invention;

FIG. 1B is a flow diagram illustrating an exemplary method of routing calls to a dual mode user equipment using a network selected according to a latest registration for the equipment according to further aspects of the invention;

FIG. 2A is a system diagram illustrating an exemplary mobile communications system at a boundary between an IMS/WiFi IP-based mobile communications network and an ANSI41 type cellular network, including a system for routing calls to a dual mode user equipment according to a latest registered network indicator according to the invention, wherein a DM UE has recently exited from the cellular network and registered in the IP-based network;

FIG. 2B is a system diagram illustrating the communications system of FIG. 2A, in which the DM UE has moved back into, and registered with, the cellular network;

FIG. 3 is a simplified call flow diagram illustrating registration of a DM UE in an IP-based mobile communications network and updating of an LRN indicator in accordance with the invention;

FIG. 4 is a simplified call flow diagram illustrating registration of the DM UE in a cellular network with the LRN indicator being again updated according to the invention;

FIG. 5 is a simplified call flow diagram illustrating incoming call routing to a DM UE most recently registered in an IP-based network according to the LRN indicator; and

FIG. 6 is a simplified call flow diagram illustrating routing of an incoming call to a DM UE most recently registered in a cellular communications network according to the LRN indicator.

### DETAILED DESCRIPTION OF THE INVENTION

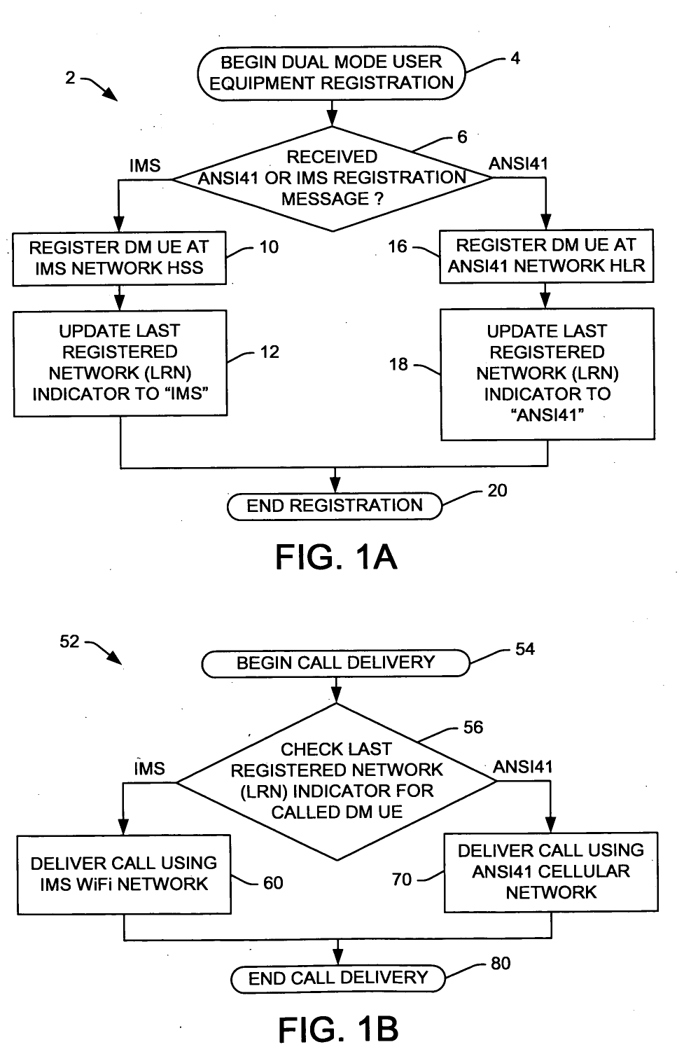

Referring initially to FIG. 1A, one or more exemplary embodiments or implementations of the present invention are hereinafter illustrated and described, wherein like reference numerals are used to refer to like elements throughout and wherein the invention is not limited to the illustrated examples. While illustrated and described below in the context of particular wireless telecommunications networks and systems, the invention finds utility in association with any type of communications apparatus and systems, including but not limited to cellular and IP-based mobile communications networks. The various aspects of the invention relate to systems and methods for managing registration and routing incoming calls for multimode (e.g., dual mode) user equipment, where the invention may be employed in association with any type of mobile communications devices or units, hereinafter variously referred to as user equipment, dual mode user equipment, multimode user equipment, etc., which are capable of communicating in more than one type of mobile communications network.

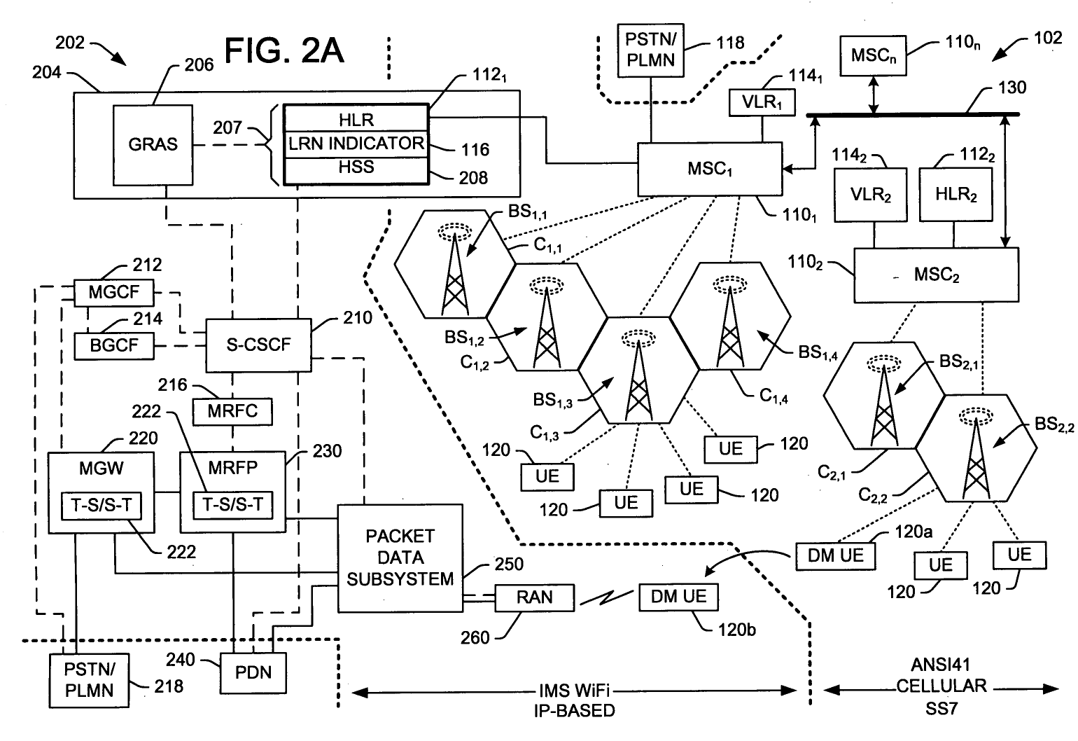

FIG. 1A illustrates an exemplary method 2 for dual or multimode user equipment registration according to the invention. While method 2 and other methods of the invention are illustrated and described hereinafter as a series of acts or events, it will be appreciated that the various methods of the invention are not limited by the illustrated ordering of such acts or events. In this regard, some acts or events may occur in different orders and/or concurrently with other acts or events apart from those illustrated and described herein, in accordance with the invention. It is further noted that not all illustrated steps may be required to implement a process in accordance with the present invention. The methods of the invention, moreover, may be implemented in association with the illustrated communications systems, messages, and user equipment, as well as with other apparatus not illustrated or described, wherein all such alternatives are contemplated as falling within the scope of the invention and the appended claims. As an example, the method 2 of FIG. 1A may be implemented in the system of FIGS. 2A and 2B for registering dual mode user equipment or in other systems not illustrated or described herein.

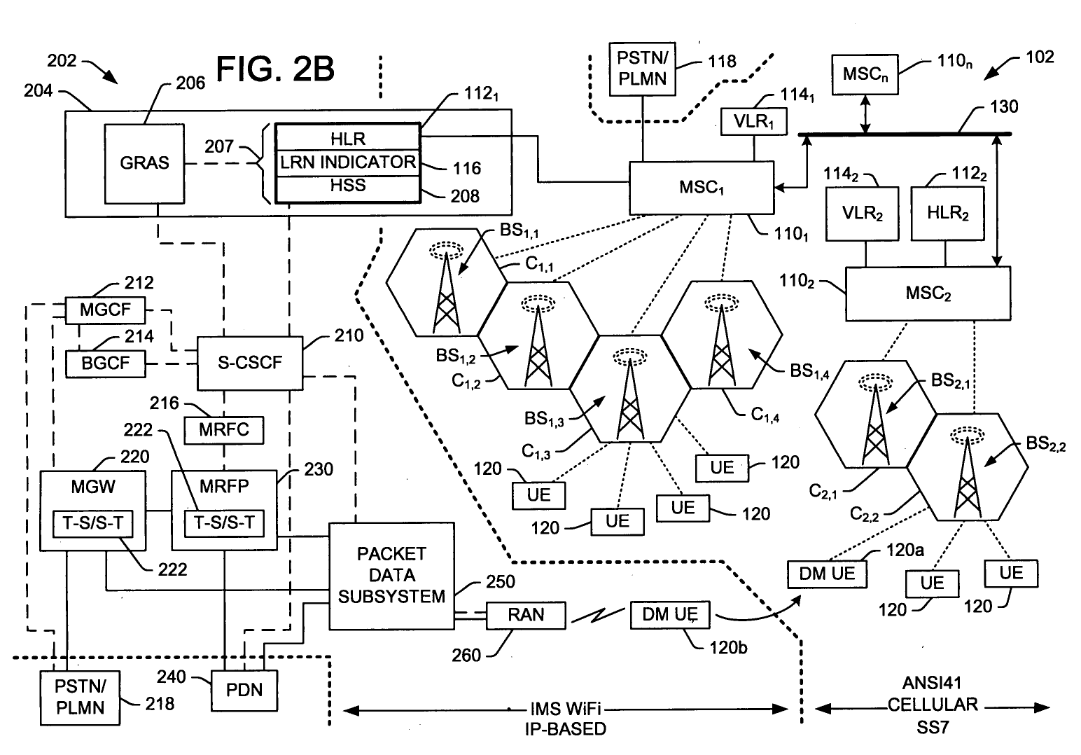

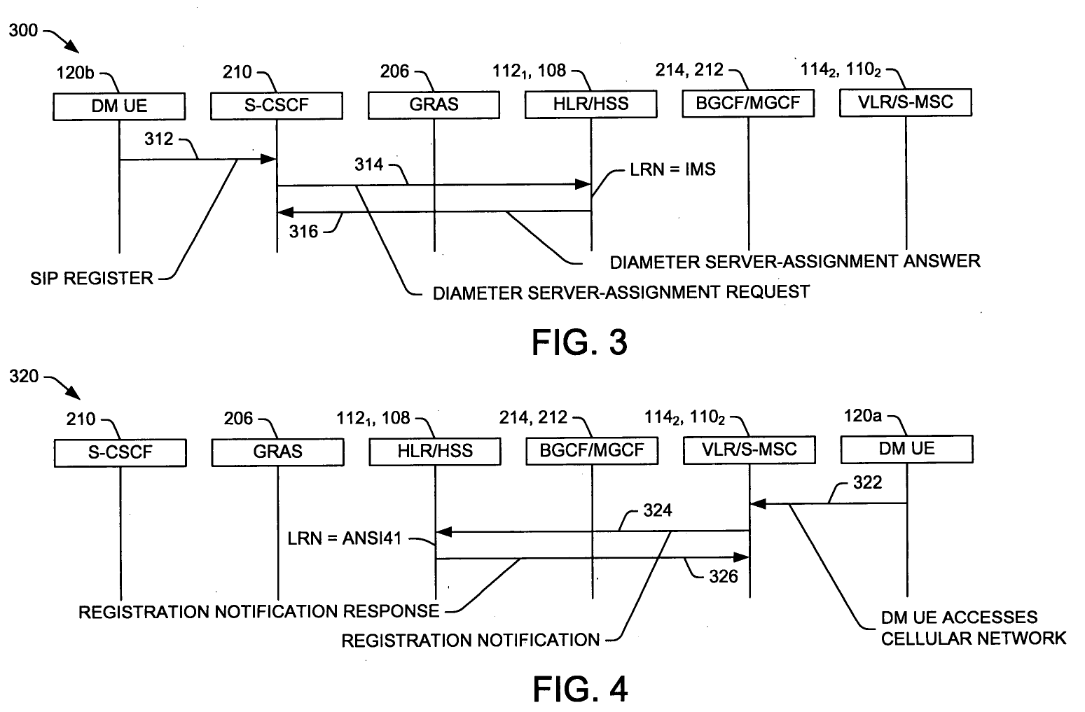

The method 2 begins at 4, with a message being received at 6 relating to registration of a DM UE in either an ANSI41 type cellular network (e.g., network 102 in FIGS. 2A and 2B below) or an IMS/WiFi IP-based network (e.g., network 202 below). Depending upon the particular network type into which the DM UE is entering, the registration or re-registration message may be an IP-based message (e.g., session initiation protocol (SIP) register message) directed to a CSCF of an IMS system, or an ANSI 41 MAP registration notification message to an MSC/HLR. FIGS. 3 and 4 below illustrate the cases for registration with an IMS/WiFi system and with an ANSI41 type cellular system, respectively. The methods of the current invention, moreover, contemplate the use of any type of message relating to registration of a multimode user equipment in a mobile communications network of any type, wherein another possible example could be a universal mobile telecommunications system/global system for mobile UMTS/GSM MAP update location message in a GSM type cellular network (not shown). In the illustrated case, a determination is made at 6 as to whether the message is for an IP-based network registration (IMS) or for a cellular network (ANSI). In the case of an attempt to register with an IP-based network (“IMS” at 6), the method 2 proceeds to 10, where the DM UE is selectively registered with the IP-based network according to the corresponding standards and registration conditions in normal fashion. In accordance with the present invention, moreover, a latest registered network (LRN) indicator is updated at 12 to indicate registration of the DM UE in the IP-based network. Any type or form of LRN indicator can be used, such as a binary flag or bit stored in an accessible memory or data store, or multiple bits or other means for indicating a particular network with which the DM UE has most recently registered, in this case a bit or byte representing “IMS” registration, after which the registration ends at 20. In the case of registration in an ANSI41 type cellular communications network (“ANSI41” at 6), the DMUE is selectively registered therein at 16 in normal fashion, and the LRN indicator for this DM UE is updated at 18 to indicate registration in the cellular network (e.g., to indicate “ANSI41” in the illustrated implementation), after which the registration method 2 ends at 20.

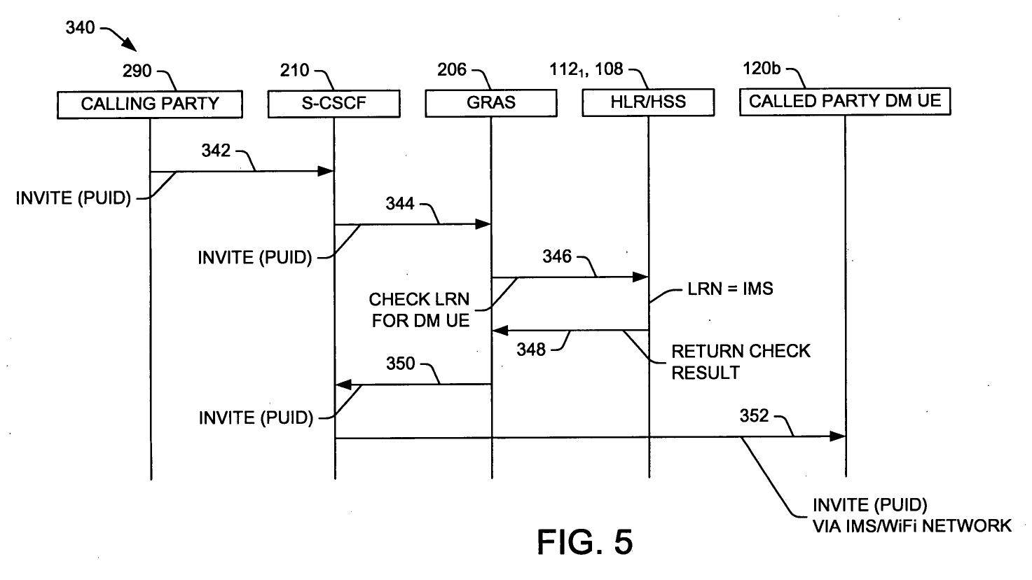

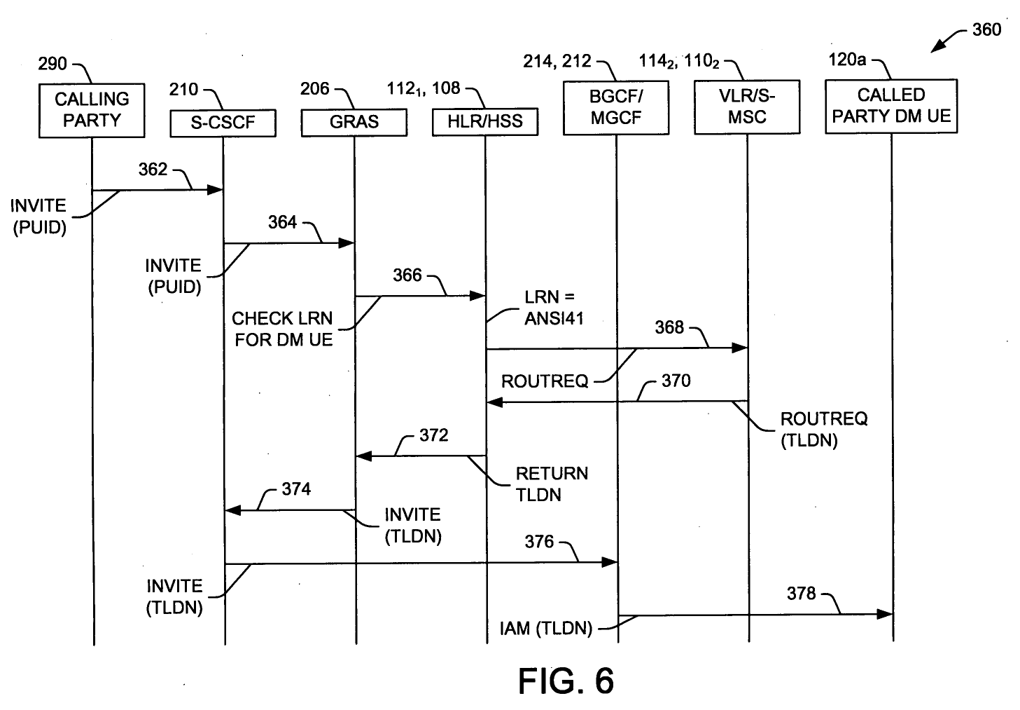

Referring now to FIG. 1B, another aspect of the invention involves call routing or delivery methods in wireless communications systems, in which the above described LRN indicator is used to selectively route or deliver incoming calls to a multimode user equipment according to the mobile communications network indicated by the LRN, where FIG. 1B illustrates one such method 52 beginning at 54. A determination is made at 56 as to the particular network indicated by the LRN (e.g., IMS or ANSI41 in this example). If the DM UE was latest registered in an IP-based network (“IMS” at 56), the call is delivered (if possible) via the IMS/WiFi network at 60 before the method 52 ends at 80. An exemplary call flow 340 for this case is illustrated in FIG. 5 below. Alternatively, if latest registered with a cellular network (“ANSI41” at 56), the incoming call is delivered or routed to the DMUE via the cellular network at 70 and the method 52 ends at 80, wherein FIG. 6 illustrates a call flow 360 for this case.

Referring also to FIGS. 2A and 2B, an exemplary mobile communications system is illustrated at an interface or boundary (shown in dashed line form in FIGS. 2A and 2B) between an ANSI41 type cellular mobile communications network 102 an IMS/WiFi IP-based network 202. In accordance with other aspects of the present invention, a system is provided for routing of incoming calls to a DM UE according to a LRN indicator 116 that is maintained (e.g., stored) in an integrated data store 207 comprising a home location register (HLR) 112₁ associated with the cellular network 102 and a home subscriber server (HSS) 208 associated with the IP-based network 202, where the LRN indicator 116 is operatively associated with either or both of the HSS 208 and the HLR 112₁. The data store 207 may be any type or form of storage facility for maintaining a current state of the LRN 116 and allowing access thereto for reading and writing of the LRN value by elements of both networks 102 and 202. In the illustrated system, moreover, the integrated data store 207 may be integrated with a global roaming application server (GRAS) 206 in a system 204 for routing incoming calls to a DM UE using a selected one of the networks 102, 202 according to the LRN 116, wherein the GRAS 206 is operatively coupled with the integrated data store 207.

The exemplary cellular network 102 includes one or more network elements including a home mobile switching module (MSC) 110₁ and a serving MSC 110₂, along with various associated base stations BS and data stores 112, 114. While the system 102 is illustrated as employing so-called mobile switching centers (MSCs) 110, other switching modules may be employed in a cellular communications system in which the aspects of the present invention are carried out, which modules can be any hardware component or components, software, or combinations thereof, and which are configured, programmed, or otherwise adapted to implement the functionality set forth herein as well as the functions of known cellular communications system switching centers including but not limited to administration functions, switching functions, etc., to switch calls between cell sites C and base stations BS thereof and a network 130. The MSCs 110 are operative to support communications to and from mobile communications units or user equipment (UE) 120 associated therewith, where FIG. 2A illustrates three exemplary MSCs 110, including a first MSC 110₁, a second MSC 110₂, and an nth MSC 110ₙ, although the system 102 may comprise any integer number “n” such switching centers or modules 110. The MSCs 110 are functionally associated with individual base stations BS located in corresponding cell sites C, wherein several such cell sites C_{1,1}, C_{1,2}, C_{1,3}, and C_{1,4} and corresponding base stations BS_{1,1}, BS_{1,2}, BS_{1,3}, and BS_{1,4} are illustrated in FIG. 2A corresponding to the exemplary first MSC 1101 and similar exemplary base stations BS_{2,1}, BS_{2,2}, BS_{3,2}, and cell sites C_{2,1} and C_{2,2} are shown for MSC₂ 110₂. The base stations BS offer communications interface to user equipment 120 which can be cell phones or any type of mobile and/or wireless communication devices. The MSCs 110 are operatively connected to a network 130, which may be an ANSI-41 wireless network, and one or more MSCs (e.g., home MSC 110₁ in FIG. 2A) may be connected or connectable to provide an interface between a public switched telephone network (PSTN) 118 and the cellular system 102 and/or other wire-based or wireless networks.

With respect to the present invention, moreover, the cellular system 102 is accessible by a dual mode UE 120a, shown in FIG. 2A moving from a location proximate cell site C_{2,2} into the IP-based network 202, and moving back again in FIG. 2B. The MSCs 110 are individually associated with corresponding HLRs 112 operating as a database of mobile subscriber profile information for a cellular wireless carrier's network, which may provide a data store with the necessary information for identifying and authenticating users subscribed to (with home location in) a given MSC 110, as well as data for matching phones, phone numbers, user accounts, service plan information, etc., and which may also provide information related to the location of individual associated customer communication devices 120 within a carrier's network, (or another carrier's network if roaming), by which incoming calls can be routed through the proper base station BS or to the GRAS 206. In addition, the profile information includes an indication of whether a given UE has multimode functionality or capabilities, such as the exemplary dual mode UE 120a is a subscriber in the cellular network 102. In one possible situation, the DM UE 120a may be subscribed (homed) with the first MSC 110₁ of the cellular network 102, where movement to the illustrated location within C_{2,2} causes registration with a serving MSC 110₂ for continued cellular service within the network 102. The corresponding HLR 112, associated with the first MSC 110₁, moreover, is integrated with the IP-based network HSS 208 in the integrated data store 207 together with the LRN 116 within the system 204.

For user equipment 120 visiting within a coverage area associated with a given MSC 110, the MSCs are also operatively associated with a corresponding visitor location register (VLR) 114 for tracking visiting equipment identity and corresponding home switching center, by which the visited MSC 110 (e.g., MSC 110₂ in one example) can accommodate provision of appropriate communication services to visiting user equipment 120. In this example, the MSC 110₁ is the home MSC for this particular mobile unit 120a, and connects calls thereto via one of the associated base stations BS_{1,1} through BS_{1,4} when the mobile unit 120a is within the service area of the MSC 110₁. When the DM UE 120a moves outside its home area and into that of MSC₂ 110₂, it registers with, and is served by MSC₂ 110₂ and the associated visitor location register VLR₂ 114₂ (MSC₂ 110₂ becomes a “serving” or “anchor” MSC in this example). Upon registration with the serving MSC₂ 110₂ and VLR₂ 114₂, the VLR₂ 114₂ provides the home HLR 112₁ with an indication of the current location of the equipment 120a, and the HLR 112₁ downloads corresponding subscriber information to the VLR₂ 114₂. In this location, when the home MSC₁ 110₁ receives a call for the user equipment 120a, the call is delivered to the serving MSC₂ 110₂, and a corresponding base station BS_{2,2} pages the DM UE 120a. If the user equipment 120a is still in the area served by the paging base station BS_{2,2}, the call is completed. The MSCs 110 may also be associated with other separate databases or data stores, wherein the various databases and functional elements of the network 102 may be distributed or integrated in any suitable fashion by which a given MSC 110 can obtain the necessary information for providing mobile communications in a defined coverage area in concert with the base stations BS.

As shown in FIG. 2A, moreover, the dual mode equipment 120a may roam outside the geographic area supported by the cellular network 102 and into that of the IMS network system 202, where the exemplary DM UE 120a is indicated as 120b at this IP-based network location in FIG. 2A. As a dual mode or multimode device, the user equipment 120b has a mobile identity number (MIN) as a UMTS/GSM cellular network identity and/or an international mobile subscriber identity (IMSI) as an ANSI41 cellular network identity, along with a private user identity (PUID) as an IMS/WiFi network identity, where each PUID can have a corresponding MIN or a corresponding IMSI. In the illustrated mobile communications system of FIGS. 2A and 2B the IP-based IMS/WiFi network 202 is also operatively coupled with the shared system 204, which provides a corresponding HSS 208 in the integrated data store 207, which is accessible by network components of the IP-based network 202. The IP-based IMS network 202 is an optionally 3GPP/3GPP2 compliant IMS/WiFi system adapted to manage and/or route multimedia communications between mobile user equipment therein, where the network 202 includes various hardware and/or software network elements, including a call session control function (CSCF) 210 operatively coupled with the GRAS 206 and the HSS 208, a media gateway (MGW) 220, a media gateway control function (MGCF) 212, a border gateway control function (BGCF) 214, a multimedia resource function processor (MRFP) 230, a media resource function control (MRFC) 216. The IMS network 202 and the network elements thereof manage call sessions and provide packet switching for multimedia communications (e.g., text messages, packetized voice communications, etc.) within the network 202, including communications with the dual mode user equipment 120b.

In the location within the IMS network 202 in FIG. 2A, the DM UE 120b is operatively connected to the IMS 202 via a radio access network (RAN) 260, which provides subscriber or visitor access, including radio base stations and control and concentration nodes (not shown) in the IMS network 202, where a packet data subsystem 250 interfaces the RAN 260 with the other network elements of the network 202 and a public data network (PDN). Data or bearer paths are shown in solid lines in the network 202 in FIGS. 2A and 2B which carry or relay the communication traffic and/or user information intended to be transmitted from one device to another, and control paths (illustrated as dashed lines) transfer associated signaling and/or control commands or messages to and between appropriate network elements and/or entities in the IMS network 202 such that call sessions are properly managed and routed with session initiation protocol (SIP) and/or other appropriate protocols being employed in the control and bearer paths. The CSCF 210, BGCF 214, MGCF 212, MRFC 216 and GRAS 206 comprise the call control and signaling functionality for the IMS 202, while the bearer paths interface with the MRFP 230 and MGW 220 to provide and support interconnectivity to external networks and/or subsystems including the packet data subsystem 250, the PDN 240 and a public switched telephone/public land mobile network (PSTN/PLMN) 218 operatively coupled with the media gateway 220.

In operation of the IP-based network 202, the CSCF 210 supports and controls multimedia sessions in which the MGCF 212 and/or the MRFC 216 are invited to call sessions to provide the bearer paths as needed for a call session, wherein the session is managed by the CSCF 210 using SIP and/or other suitable protocols. The CSCF 210 thus provides incoming call gateway (ICGW), call control function (CCF), serving profile database (SPD) and address handling (AH) functions. The ICGW function operates as a session entry point and routes incoming calls and the CCF executes call setup/termination and state/event management and interacts with the MGCF 212 for calls to or from the PSTN/PLMN 218, and with the BGCF 214 for calls to the PSTN/PLMN 218 to determine the appropriate MGCF 212 to use. In addition, the CCF function controls the MRFP 230 via the MRFC 216, where the MRFC 216 interprets information or signals coming from the CSCF 210 and controls the MFRP 230 accordingly, in order to support conferencing and other multi-party services.

With respect to subscriber registrations (e.g., method 2 in FIG. 1A above), SIP level registrations from subscribers in the IP-based network 202 are processed via the CCF function, which may also provide service trigger mechanisms to the GRAS 206 or other application server (not shown) to invoke services provided thereby (either locally, at the GRAS 206, or elsewhere). The CCF function, moreover, operates to report call events for billing, auditing, intercept or other purposes, and may query the address handling functionality to ascertain whether a requested outgoing communication is allowed given the current subscription. The serving profile database function interacts with the HSS 208 to receive and cache user profile information, including an indication of whether a given user equipment is a multimode device, wherein the address handling functionality includes address analysis, translation, modification (when appropriate), and/or mapping.

The media gateway 220 operates in the IP-based network 202 as an interface for bearer path transfer between the network 202 and other networks (e.g., PSTN 218), and provides resources for translation and encoding, transcoding, compression, packetizing, depacketizing, etc. with respect to bearer path traffic. The gateway 220 also interacts with the MGCF 212, which in turn interprets signaling from the CSCF 210 and controls the MGW 220 accordingly for resource allocation, bearer path control, and payload processing. In addition, T-S/S-T elements 222 are incorporated in the gateway 220 and MRFP 230 for selective conversion of text into speech and/or speech into text. The media gateway control function 212 communicates with the CSCF 210 to control the call state for media channels on one or more media gateways, as well as to perform conversions between legacy and 3G UMTS/CDMA network call control protocols. In addition, the multimedia resource function control 216 manages media stream resources in the MRFP 230, which also acts as a bearer path interface between the network 202 and external networks and/or subsystems, while providing conferencing, multiple party communications, or other media services with respect to the gateway 220.

As discussed above, the HSS 208 of the IMS network 202 is integrated together with the cellular system HLR 112₁ and the LRN indicator 116, where the HSS 208 maintains subscriber and system related data, user profiles, locations, etc., along with an indication of whether a given user equipment 120 has dual mode capabilities. In this integrated implementation, moreover, the HSS 208 may optionally contain the HLR functionality 112₁ and/or authentication, authorization, and accounting (AAA) functions, wherein the LRN 116 of the present invention may be stored in the HLR portion 112a, in the HSS portion 208, or both, of the integrated data store 207, or elsewhere in either system 102 or system 202 in a location accessible, directly or indirectly, for indicating the latest registered network for selective call delivery as described above with respect to FIG. 1B. In this regard, any number of LRN indicators or one LRN indicator with multiple values may be maintained in the data store 207, which are individually associated with multimode user equipment in the system. The HSS portion 208 of the data store 207, moreover, may include memory or storage resources to provide for user identification through numbering and addressing information, user security information, including network access control information for authentication and authorization, user location information for user registration and locating, as well as user profiles including indications of dual mode functionality and identification of the services subscribed to and other service specific information.

Referring to FIGS. 2A and 3, FIG. 2A illustrates a situation in which the various aspects of the present invention may advantageously be employed for registration management of the dual mode UE 120b upon entry into the IMS system 202, wherein the DM UE 120b may be a subscriber of or to the IMS/WiFi system 202 as assumed in the following description, and/or may be a subscriber of the cellular system 102. FIG. 3 illustrates a simplified call flow 300 showing registration or re-registration of the DM UE 120b in the IMS network 202, wherein the UE 120b sends a SIP register message 312 to the serving CSCF 210. The CSCF 210, in turn, sends a diameter server-assignment request 314 to the integrated HLR/HSS 112₁, 108 (IMS registration message received at 6 in FIG. 1A above). The HLR/HSS 112₁, 108 updates the LRN indicator 116 (12 in FIG. 1A) to indicate “IMS” as the latest registered network for the DM UE 120b, and responds with a diameter server-assignment answer message 316 to complete the registration of the UE 120b in the IP-based IMS network 202.

Referring to FIGS. 2B and 4, another situation is illustrated, wherein the dual mode user equipment moves back to the ANSI41 cellular network 102 (the DM UE is indicated as 120a in this location). Upon entering (or re-entering) the cellular network 102, the UE 120a registers (or re-registers) with the network 102. As shown in a simplified registration call flow 320 of FIG. 4, the DM UE 120a sends a registration message 322 to the serving VLR 114₂/MSC 110₂, which in turn sends an ANSI41 registration notification invoke message (REGNOT) 324 to the HLR/HSS 112₁, 108 in the data store 207 of integrated system 204 (e.g., ANS141 registration message received at 6 in FIG. 1A). This causes the HLR/HSS 112₁, 108 to update the LRN indicator 116 (18 in FIG. 1A) to indicate “ANSI41”, and the HLR/HSS 112₁, 108 responds with a registration notification return result message 326 for registration of the DM UE 120a in the ANSI41 network 102. As noted above, the DM UE 120a, 120b may move back and forth between the networks 102, 202 any number of times, wherein the registration method 2 of the invention and the system 204 operate to ensure that the LRN 116 indicates the network 102 or 202 with which the DM UE 120a, 120b has most recently registered.

Referring now to FIGS. 1B, 5, and 6, the updated LRN indicator 116 resulting from the registration aspects of the invention facilitates efficient and expeditious delivery or routing of incoming calls to the dual mode equipment 120a, 120b regardless of which network 102, 202 it resides in. In this regard, the integrated system 204 of FIGS. 2A and 2B provides for updating and maintain the LRN indicator 116 and similar indicators for other dual or multimode devices (not shown), together with systems such as the GRAS 206 or other suitable hardware and/or software for routing an incoming call to a given dual mode user equipment via a selected one of the networks 102, 202 according to the LRN indicator 116. In one implementation, LRN indicators 116 may be maintained for each dual mode UE identified with a MIN or an IMSI. FIG. 5 illustrates an exemplary call flow 340 for the case where the UE 120b is a subscriber to the IMS network 202 and has most recently registered with the network 202, in which case a calling party 290 initiates an incoming call using an invite (PUID) message 342 to the serving CSCF 210. Since the user equipment 120b is a dual mode device, the serving CSCF 210 sends an invite message 344 to the GRAS 206 for routing the incoming call. In accordance with the invention, the GRAS 206 or other suitable network or system element checks the LRN indicator 116 corresponding to the DM called party DM UE 120b (56 in the call delivery method 52 of FIG. 1B above) using an access message 346 to the HLR/HSS 112₁, 108, whereupon the HLR/HSS 112₁, 108 returns the check result 348 indicating to the GRAS 206 that the LRN indicates the latest registration for the DM UE 120b is with the IMS network 202 (e.g., “IMS” determined at 56 in FIG. 1B). Accordingly, the GRAS 206 provides an invite (PUID) message 350 to the serving CSCF 210, which then sends an invite (PUID) message to the multimode user equipment 120b to deliver the call via the IMS network 202 (60 in FIG. 1B). It is noted that usage of the LRN 116 allows the GRAS 206 to forgo useless attempts to route the incoming call through the cellular network 102 in accordance with the invention, even though the network 102 may indeed have a registration for the equipment 120a.

FIG. 6 shows an incoming call delivery flow 360 for another situation in which the UE 120a is again an original subscriber to the IMS network 202, but has moved back into, and registered with, the cellular network 102 (FIG. 2B above). In this case, the calling party 290 again provides an invite PUID message 362 to the serving CSCF 210, which in turn sends an invite message 364 to the GRAS 206. As in the above example of FIG. 5, the GRAS 206 checks the LRN 116 (56 in FIG. 1B) using an access message 366 to the HLR/HSS 112₁, 108, and the HLR/HSS 112₁, 108. However, since the LRN 116 in this case indicates most recent registration with the ANSI 41 network 102 (ANSI41 at 56 in FIG. 1B), the HLR/HSS 112₁, 108 sends a route request (ROUTREQ) ANSI41 message 368 to the VLR 114₂/serving MSC 110₂, which then responds with a route request (TLDN) message 370, and the HLR/HSS 112₁, 108 provides a return (TLDN) message 372 to the GRAS 206. The GRAS 206 then proceeds to deliver the call to the DM UE 120a via the cellular network 102 (70 in FIG. 1B) by providing an invite (TLDN) message 374 to the CSCF 210, whereupon the CSCF 210 sends an invite (TLDN) message 376 to the BGCF/MGCF 214, 212 and an IAM (TLDN) message 378 is sent to the called party DM UE 120a to complete the call.

It is noted that the call routing or delivery aspects illustrated and described above can also be implemented using suitable messaging and network elements in cases in which the called party DM UE 120a is a subscriber to the ANSI41 cellular system 102 (e.g., or in a GSM type cellular system), for example, wherein MSC 110₁ is the home MSC and MSC 110₂ is a serving MSC. In this case the incoming call from the calling party 290 would initially be sent to the home MSC 110₁, which would determine that the intended recipient 120a, 120b is a dual mode device, whereupon the GRAS 206 would again be employed to route the call according to the value of the LRN indicator 116. Many other implementations are possible for the various aspects of the invention, for instance, where a multimode device could be operative to communicate in more than two types of networks, for example, including operational functionality for IMS/WiFi, ANSI41 cellular, and GSM cellular networks, with the LRN indicator including an appropriate number of bits or otherwise being capable of indicating one of several possible networks in which the DM UE was most recently registered. In addition, it is noted that the LRN may be maintained in any storage medium that is accessible directly or indirectly by elements of the networks in any fashion that allows an application server (e.g., GRAS 206) or other system or network element (whether hardware or software or combinations thereof) to update the LRN upon new device registration and to ascertain the current LRN value indicating the most recent registration, by which system resources can be conserved by routing incoming calls only through the network corresponding to the latest registration for a given multimode user equipment. In this regard, the above illustrations and description are merely examples and are not exhaustive of the possible implementations or embodiments falling within the scope of the present invention and the appended claims.

While the invention has been illustrated and described with respect to one or more exemplary implementations or embodiments, equivalent alterations and modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A method for managing registration of dual mode user equipment in a mobile communications system, the method comprising:
receiving a message requesting registration by a dual mode user equipment in a first mobile communications network;
selectively registering the dual mode user equipment in the first mobile communications network; and
updating a latest registered network indicator in a data store associated with the first communications network, the updated latest registered network indicator being indicative of the first mobile communications network.

2. The method of claim 1, wherein the data store is accessible by a plurality of mobile communications networks including the first mobile communications network and a second mobile communications network, the method further comprising:
receiving a message requesting registration by the dual mode user equipment in the second mobile communications network;
selectively registering the dual mode user equipment in the second mobile communications network; and
updating the latest registered network indicator to be indicative of the second mobile communications network.

3. The method of claim 2, further comprising selectively routing an incoming call to the dual mode user equipment using the network indicated by the latest registered network indicator.

4. The method of claim 2, wherein one of the first and second mobile communications networks is a cellular network and the other is an internet protocol-based network.

5. The method of claim 4, wherein the data store is an integrated data store comprising a home location register associated with the cellular network and a home subscriber server associated with the internet protocol-based network, and wherein the latest registered network indicator is associated with at least one of the home location register and the home subscriber server.

6. The method of claim 1, wherein the first mobile communications network is one of a cellular network and an internet protocol-based network.

7. The method of claim 1, further comprising selectively routing an incoming call to the dual mode user equipment using a network indicated by the latest registered network indicator.

8. A method of routing an incoming call to a dual mode user equipment in a mobile communications system, the method comprising:
checking a latest registered network indicator associated with the dual mode user equipment, the latest registered network indicator being indicative of one of a plurality of mobile communications networks; and
routing the incoming call to the dual mode user equipment via a selected one of the plurality of mobile communications networks according to the latest registered network indicator.

9. The method of claim 8, further comprising updating the latest registered network indicator when the dual mode user equipment registers with another of the plurality of mobile communications networks.

10. The method of claim 9, wherein the plurality of mobile communications networks includes at least one cellular network and at least one internet protocol-based network.

11. The method of claim 8, wherein the plurality of mobile communications networks includes at least one cellular network and at least one internet protocol-based network.

12. A system for routing incoming calls to a dual mode user equipment using one of a plurality of mobile communications networks, comprising:
a latest registered network indicator for indicating one of a plurality of mobile communications networks with which a given dual mode user equipment has most recently registered; and
means for routing the incoming call to the given dual mode user equipment via a selected one of the plurality of mobile communications networks according to the latest registered network indicator.

13. The system of claim 12, wherein the latest registered network indicator is maintained in a data store accessible by the plurality of mobile communications networks.

14. The system of claim 13, wherein the data store comprises a home location register associated with a cellular network and a home subscriber server associated with an internet protocol-based network.

15. The system of claim 14, wherein the latest registered network indicator is associated with at least one of the home location register and the home subscriber server.

16. The system of claim 12, wherein the latest registered network indicator is stored in one of a home location register associated with a cellular network and a home subscriber server associated with an internet protocol-based network.

17. The system of claim 12, wherein the means for routing comprises a global roaming application server associated with the plurality of mobile communications networks.

18. The system of claim 17, wherein the dual mode user equipment is a subscriber in a first network of the plurality of mobile communications networks, and wherein a network element of the first network is operative to direct the incoming call to the global roaming application server for routing the incoming call to the given dual mode user equipment via a selected one of the plurality of mobile communications networks according to the latest registered network indicator.

19. The system of claim 18, wherein the first network is a cellular network and the network element is at least one of a home location register and a mobile switching center.

20. The system of claim 18, wherein the first network is an internet protocol based network and the network element is a call state control function.
